(19) United States
(12) Patent Application Publication
(10) Pub. No.: US 2026/0122517 A1
(43) Pub. Date: Apr. 30, 2026

(54) APPARATUS AND METHOD FOR DETERMINING CHANNEL TYPE BASED ON MACHINE LEARNING AND ADAPTIVE TRANSMISSION BASED ON CHANNEL TYPE

(71) Applicant: Samsung Electronics Co., Ltd., Suwon-si (KR)

(72) Inventors: Eunsung Jeon, Suwon-si (KR); Myeongjin Kim, Suwon-si (KR); Chulho Chung, Suwon-si (KR)

(21) Appl. No.: 18/990,352

(22) Filed: Dec. 20, 2024

(30) Foreign Application Priority Data
Dec. 26, 2023 (KR) 10-2023-0191852
May 7, 2024 (KR) 10-2024-0059882

(51) Int. Cl. H04W 24/08; H04L 41/16; H04W 24/10; H04W 84/12

(52) U.S. Cl. CPC H04W 24/08; H04L 41/16; H04W 24/10; H04W 84/12

(57) ABSTRACT

Provided is a method of operating a first device communicating with a second device through a channel in a wireless local area network (WLAN) system including the first device and the second device, the operating method including calculating state data of the channel using a signal received from the second device, classifying a class of a channel type based on a first neural network using the state data as input, classifying the channel type based on the classified class of the channel type and a second neural network using the state data as input, and feeding back the classified channel type to the second device.

### CROSS-REFERENCE TO RELATED APPLICATIONS

This application is based on and claims priority under 35 U.S.C. § 119 to Korean Patent Application Nos. 10-2023-0191852, filed on Dec. 26, 2023, and 10-2024-0059882, filed on May 7, 2024, in the Korean Intellectual Property Office, the disclosures of which are incorporated by reference herein in their entireties.

### BACKGROUND

Aspects of the inventive concept relate to wireless communication, and specifically, to an apparatus and method for determining a channel type based on machine learning and adaptive transmission based on the channel type.

As an example of wireless communication, a wireless local area network (WLAN) is technology that connects two or more devices to each other using a wireless signal transmission method, and WLAN technology may be based on the IEEE 802.11 standard. The 802.11 standard has developed into 802.11b, 802.11a, 802.11g, 802.11n, 802.11ac, 802.11ax, and the like, and may support transmission speeds up to 1 GByte/s based on orthogonal frequency-division multiplexing (OFDM) technology.

In a Multiple User-Multiple Input Multiple Output (MU-MIMO) communication environment, a beamforming process may be used to improve communication performance. Specifically, a beamformer (e.g., an access point) that performs a beamforming process may receive feedback on a downlink channel from a beamformee by performing a channel sounding procedure with the beamformee (e.g., a station) and determine a beamforming matrix based on the received feedback on the premise of reciprocity between the downlink channel and an uplink channel. The beamformer may perform beamforming on data transmitted to the beamformer through the uplink channel based on the determined beamforming matrix.

### SUMMARY

Aspects of the inventive concept provide an apparatus and method configured to make a beamformee learn a channel type and feed a determined channel type back and a beamformer adaptively set up a transmission technique.

According to an aspect of the inventive concept, there is provided a method of operating a first device communicating with a second device through a channel in a wireless local area network (WLAN) system including the first device and the second device, the operating method including calculating state data of the channel using a signal received from the second device, classifying a class of a channel type based on a first neural network using the state data as input, classifying the channel type based on the classified class of the channel type and a second neural network using the state data as input, and feeding back the classified channel type to the second device.

According to another aspect of the inventive concept, there is provided a method of operating a second device communicating with a first device through a channel in a wireless local area network (WLAN) system including the first device and the second device, the operating method including transmitting a signal including information requesting the first device for feedback of a channel type, receiving feedback regarding the channel type from the first device, and determining a modulation coding scheme (MCS) level and/or a transmission frequency band of a signal transmitted to the first device based at least on the fedback channel type and a signal to noise ratio (SNR).

According to another aspect of the inventive concept, there is provided a wireless local area network (WLAN) system including a first device configured to calculate state data of a channel using a signal received from a second device, classify a class of a channel type class based on a first neural network using the state data as input, classify the channel type based on the classified class of the channel type, and a second neural network using the state data as input, and feed the classified channel type back to the second device, and a second device configured to determine a modulation coding scheme (MCS) level and/or a transmission frequency band of a signal transmitted to the first device at least based on the fedback channel type.

### BRIEF DESCRIPTION OF THE DRAWINGS

Embodiments will be more clearly understood from the following detailed description taken in conjunction with the accompanying drawings in which:

FIG. 1 is a diagram illustrating a wireless communication system according to an embodiment;

FIG. 2 is a block diagram illustrating a wireless communication system according to an embodiment;

FIG. 3 is a detailed block diagram of a controller included in a beamformee according to an embodiment;

FIG. 4A is a diagram illustrating a first neural network model according to a comparative example;

FIG. 4B illustrates an allocation table of subcarrier grouping according to a comparative example;

FIG. 4C illustrates an allocation table of codebook sizes according to a comparative example;

FIG. 5A is a diagram illustrating a second neural network model according to an embodiment;

FIG. 5B illustrates a table for channel type feedback according to an embodiment;

FIG. 6A is a timing diagram for explaining feedback based on a trigger frame according to an embodiment;

FIG. 6B is a table illustrating trigger type subfield values according to an embodiment;

FIG. 7 is a timing diagram for explaining CBR-based feedback according to an embodiment;

FIG. 8 is a diagram illustrating feedback based on a MAC header, according to an embodiment;

FIG. 9 is a table illustrating an adaptive MCS level according to an embodiment;

FIG. 10 is a table illustrating adaptive mmWave transmission according to an embodiment;

FIG. 11A is a timing diagram for adaptively applying an MCS level based on a trigger frame according to an embodiment;

FIG. 11B is a timing diagram adaptively applying mmWave transmission based on a trigger frame according to an embodiment;

FIG. 12A illustrates an example of feeding back a channel state based on a fine timing measurement (FTM) action frame according to embodiments;

FIG. 12B is a signal exchange diagram for an FTM according to embodiments; and

FIG. 13 is a conceptual diagram illustrating an IoT network system to which embodiments of the inventive concept are applied.

### DETAILED DESCRIPTION OF THE EMBODIMENTS

Hereinafter, embodiments of the inventive concept will be described in detail with reference to the accompanying drawings.

Advantages and features of the inventive concept and methods for achieving the advantages and features will become apparent with reference to the embodiments described below in detail together with the accompanying drawings. However, aspects of the inventive concept are not limited to the embodiments shown below, but will be implemented in various different forms, may be cross-used, and only the embodiments ensure that the description of the inventive concept is complete. In addition, the disclosure is provided to fully inform those skilled in the art to which the disclosure belongs of the scope of the disclosure, and the scope of rights of the disclosure is only defined by the scope of the claims. In addition, specific configurations described only in each embodiment of the inventive concept may also be used in other embodiments. Throughout the specification, the same reference numerals refer to the same components.

The terms used in the specification are intended to describe embodiments and are not intended to limit the scope of the inventive concept. In the specification, the singular form also includes the plural form unless specifically stated in the disclosure. As used herein, “comprises” and/or “comprising” do not preclude the presence or addition of one or more other components, steps, operations and/or elements.

Unless otherwise defined, all terms (including technical and scientific terms) used in this specification may be used with meanings that may be commonly understood by those skilled in the art to which this disclosure pertains. In addition, terms that are commonly used in dictionaries are not ideally or over-interpreted unless clearly and specifically defined.

In addition, when specifically describing embodiments of the inventive concept, the main focus will be on orthogonal frequency-division multiplexing (OFDM) or orthogonal frequency-division multiple access (OFDMA)-based wireless communication systems, especially the IEEE 802.11 standard. However, aspects of the inventive concept may be applied to other communication systems (e.g., cellular communication systems, such as Long Term Evolution (LTE), LTE-Advanced (LTE-A), New Radio (NR), Wireless Broadband (WiBro), or Global System for Mobile communication (GSM) or short-range communication systems, such as Bluetooth and Near Field Communication (NFC)) with similar technical background and channel type, through slight modifications without significantly departing from the scope of the present disclosure. This may be possible at the discretion of a person skilled in the technical field of the inventive concept.

Various functions described below may be implemented or supported by Artificial Intelligence technology or one or more computer programs, each of which includes computer-readable program code and is implemented on a computer-readable medium. The terms “application” and “program” refer to one or more computer programs, software components, instruction sets, procedures, functions, objects, classes, instances, related data, or parts of them suitable for implementation of suitable computer-readable program code. The term “computer-readable program code” includes all types of computer code, including source code, object code, and execution code. The term “computer-readable media” includes any type of media that may be accessed by a computer, such as read only memory (ROM), random access memory (RAM), hard disk drives, compact discs (CDs), digital video discs (DVDs), or any other type of memory. A “non-transitory” computer-readable medium excludes wired, wireless, optical, or other communication links that transmit temporary electricity or other signals. A non-transitory computer-readable medium includes media where data can be permanently stored and media where data can be stored and later overwritten, such as a rewritable optical disc or an erasable memory device.

In various embodiments of the inventive concept described below, a hardware approach will be described as an example. However, since various embodiments of the inventive concept include technologies using both hardware and software, various embodiments of the inventive concept do not exclude a software-based approach.

In addition, terms used in the description given later are illustrated for convenience of explanation. Therefore, the present disclosure is not limited to terms described below, and other terms having equivalent technical meanings may be used.

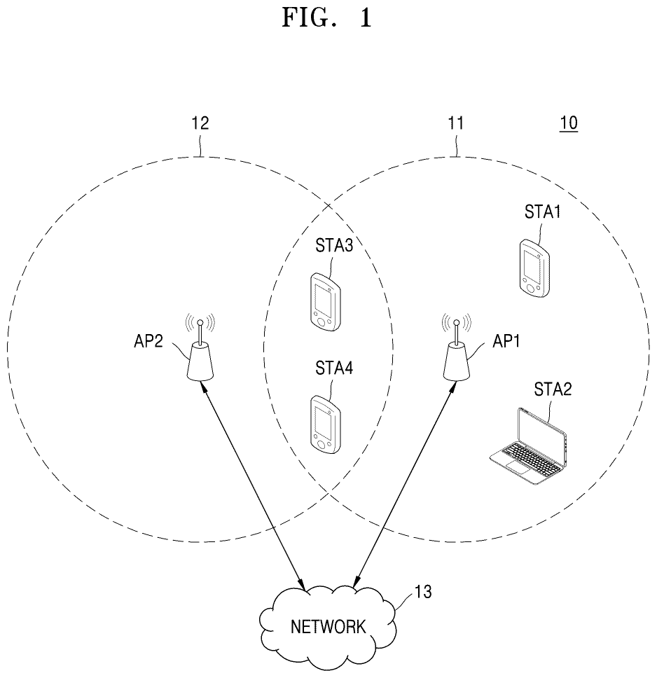

FIG. 1 is a diagram illustrating a wireless communication system 10 according to an embodiment.

FIG. 1 illustrates a wireless local area network (WLAN) system as an example of a wireless communication system 10. Referring to FIG. 1, the wireless communication system 10 may include first and second access points AP1 and AP2, a first station STA1, a second station STA2, a third station STA3, and a fourth station STA4. The first and second access points AP1 and AP2 may connect to a network 13 including the Internet, an Internet protocol (IP) network, or any other network. The first access point AP1 may provide access to the network 13 within a first coverage area 11 to the first station STA1, the second station STA2, the third station STA3, and the fourth station STA4, and the second access point AP2 may also provide access to the network 13 to the third and fourth stations STA3 and STA4 within a second coverage area 12. In some embodiments, the first and second access points AP1 and AP2 may communicate with at least one of the first station STA1, the second station STA2, the third station STA3, and the fourth station STA4 based on wireless fidelity (Wi-Fi) or any other WLAN access technology.

The access points AP1 and AP2 may be referred to as a router, gateway, etc., and the stations STA1-STA4 may be referred to as a mobile station, a subscriber station, a terminal, a mobile terminal, a wireless terminal, user equipment, a user, etc. The stations STA1-STA4 may be a portable device such as a mobile phone, a laptop computer, or a wearable device, or may be a stationary device such as a desktop computer or a smart TV. In the specification, the access points AP1 and AP2 may be referred to as a first device, and the stations STA1-STA4 may be referred to as a second device.

The first and second access points AP1 and AP2 may allocate at least one resource unit (RU) to at least one of the first to fourth stations STA1 to STA4. The first and second access points AP1 and AP2 may transmit data through at least one allocated RU, and at least one station may receive data through at least one allocated RU. In 802.11ax, access points AP1 and AP2 may allocate only a single RU to at least one station, while in 802.11be (hereinafter referred to as EHT) or next-generation IEEE 802.11 standards (hereinafter referred to as EHT+), access points AP1 and AP2 may allocate multi-resource units (MRUs) including two or more resource units to at least one station. For example, the first access point AP1 may allocate multiple RUs to at least one of the first station STA1, the second station STA2, the third station STA3, and the fourth station STA4 and transmit data through the allocated MRUs.

The first and second access points AP1 and AP2 may communicate with at least one of the first to fourth stations STA1 to STA4 using a beamforming technique. For example, single-user beamforming may improve the receiving performance of a single user, and multi-user beamforming may improve the receiving performance of the entire multi-user by eliminating interference between multiple users.

At least one of the first to fourth stations STA1 to STA4 may communicate with the first and second access points AP1 and AP2 using a beamforming technique. For example, single-user beamforming may improve the receiving performance of a single user, and multi-user beamforming may improve the receiving performance of the entire multi-user by eliminating interference between multiple users.

According to an embodiment, each of the first to fourth stations STA1 to STA4 may infer a channel type based on a neural network. The neural network may have a feedback neural network structure. For example, after completing learning of an n-th iteration, the neural network may perform learning of an (n+1)-th iteration by re-inputting a channel type, which is a learning result. The first to fourth stations STA1 to STA4 may feed the determined channel type back to the first and second access points AP1 and AP2.

According to an embodiment, the first and second access points AP1 and AP2 may adaptively change a transmission technique based on a feedback of the channel type. For example, the first and second access points AP1 and AP2 may determine a MCS level and whether to transmit mmWave, based at least on the received channel type and signal to noise ratio (SNR), the number of transmission and reception antennas, transmission bandwidth, and the number of transmission streams.

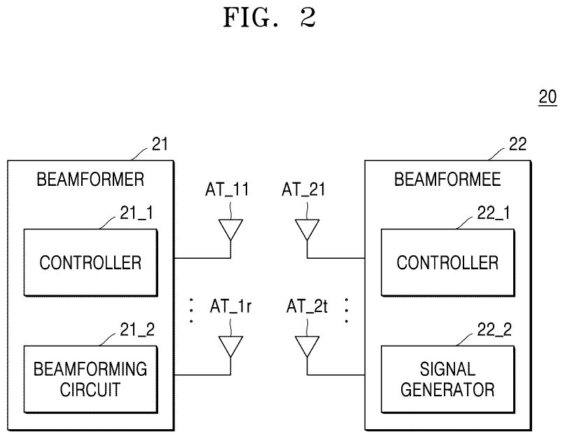

FIG. 2 is a block diagram illustrating a wireless communication system 20 according to an embodiment.

Referring to FIG. 2, a wireless communication system 20 may include a beamformer 21 and a beamformee 22. The beamformer 21 and the beamformee 22 may communicate with each other. Each of the beamformer 21 and the beamformee 22 may be any device that communicates in the wireless communication system 20, and may be referred to as a device for wireless communication.

According to an embodiment, each of the beamformer 21 and the beamformee 22 may be an access point (or a first device) and a station (or a second device) of a WLAN system. However, embodiments are not limited thereto, and the beamformer 21 may be a station (or a second device), and the beamformee 22 may be an access point (or a first device).

According to an embodiment, the beamformer 21 may include a controller 21_1, a beamforming circuit 21_2, and a plurality of first antennas AT_11 to AT_1r. The beamformee 22 may include a controller 22_1, a signal generator 22_2, and a plurality of second antennas AT_21 to AT_2t. The beamformer 21 may transmit beamformed data to the beamformee 22 through the plurality of first antennas AT_11 to AT_1r. The beamformee 22 may receive beamformed data through the plurality of second antennas AT_21 to AT_2t.

According to an embodiment, the controller 21_1 may control the overall operation for communication with the beamformee 22. For example, the controller 21_1 may control a channel sounding procedure and data communication with the beamformee 22. Specifically, the controller 21_1 may transmit a null data packet announcement (NDPA) signal and a null data packet (NDP) to the beamformee 22 in the channel sounding procedure, or process compressed beamforming report (CBR) feedback received from the beamformee 22 so that the beamforming circuit 21_2 may use the CBR feedback.

According to an embodiment, the beamforming circuit 21_2 may determine a beamforming matrix based on the CBR feedback. The controller 21_1 may generate beamformed data using the beamforming matrix determined by the beamforming circuit 21_2 and transmit the beamformed data to the beamformee 22. The controller 21_1 may generate beamformed data using the beamforming matrix determined in the data communication section until the channel type is changed.

The controller 22_1 of the beamformee 22 may control the overall operation for communication with the beamformer 21. For example, the controller 22_1 may control a channel sounding procedure and data communication with the beamformer 21. Specifically, the controller 22_1 may transmit CBR feedback to the beamformer 21 in the channel sounding procedure, or transmit an acknowledgement (ACK) signal for beamformed data to the beamformer 21.

In FIG. 2, the controller 21_1 and the beamforming circuit 21_2 of the beamformer 21 are illustrated as separate components, respectively, and the controller 22_1 and the signal generator 22_2 of the beamformee 22 are illustrated as separate components, respectively, but these are intended to clearly explain the operations of the beamformer 21 and the beamformer 22, and the controller 21_1 and embodiments are not limited thereto. The controller 21_1 and the beamforming circuit 21_2 may be integrated as a single processing circuit or implemented as various circuits, and likewise, the controller 22_1 and the signal generator 22_2 may be integrated as a single processing circuit or implemented as various circuits. In addition, the operation of the controller 21_1 and the beamforming circuit 21_2 may be understood as the operation of the beamformer 21, and the operations of the controller 22_1 and the signal generation circuit 22_2 may be understood as the operation of the beamformee 22.

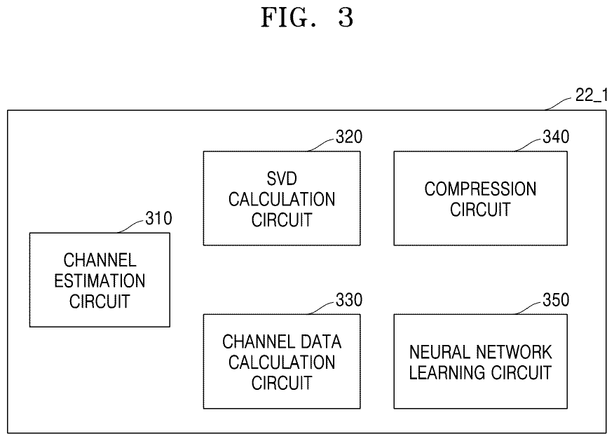

FIG. 3 is a detailed block diagram of a controller included in a beamformee according to an embodiment.

Referring to FIG. 3, the controller (e.g., 22_1 of FIG. 2) of the beamformee (e.g., 22 of FIG. 2) may include a channel estimation circuit 310, a singular value decomposition (SVD) calculation circuit 320, a channel data calculation circuit 330, a compression circuit 340, and a neural network learning circuit 350.

According to an embodiment, the channel estimation circuit 310 may estimate a channel Ĥₖ based on a received signal. The received signal may correspond to a NDP. The received signal may be represented according to the following equation.

$${Y}_{k} = {H}_{k} {S}_{k} + {N}_{k} \qquad [ Equation 1 ]$$

Here, Y corresponds to a received signal, S corresponds to a Nₜ×1 sounding signal vector, H corresponds to a channel matrix indicating a frequency response, and a size is Nᵣ×Nₜ. k may correspond to a subcarrier index. The channel estimation circuit 310 may provide the channel Ĥₖ obtained by performing channel estimation to the SVD calculation circuit 320 and the channel data calculation circuit 330.

According to an embodiment, the channel data calculation circuit 330 may acquire data input to a neural network for determining a channel type. For example, the channel data calculation circuit 330 may calculate state data of a channel. The state data may include a variance of a channel frequency response and a channel delay spread. The channel data calculation circuit 330 may receive the estimated channel from the channel estimation circuit 310 and calculate a variance of the channel frequency response according to the following equation.

$${σ}_{H}^{2} = \frac{1}{{N}_{r} {N}_{t}} {\sum }_{i = 0}^{{N}_{r} - 1} {{{\sum }_{j = 0}}^{{N}_{t} - 1}}^{} [ \frac{1}{N} {\sum }_{k = 0}^{N - 1} {\vert {\hat{H}}_{k} ( i , j ) \vert}^{2} - {( \frac{1}{N} {\sum }_{k = 0}^{N - 1} \vert {\hat{H}}_{k} ( i , j ) \vert )}^{2} ] \qquad [ Equation 2 ]$$

Here, Ĥₖ(i,j) is the i-th and j-th elements of the channel matrix Ĥₖ estimated through NDP decoding, and N is the number of subcarriers. Nt and Nr are the numbers of transmitter and receiver antennas, respectively. In addition, the channel data calculation circuit 330 may calculate the channel delay spread according to the following equation based on the principle that the variance of the channel frequency response is large if the channel delay spread value is large and the variance of the channel delay spread value is small if the channel delay spread value is small.

$$\text{?} = \frac{1}{{N}_{r} {N}_{t}} {\sum }_{i = 0}^{{N}_{r} - 1} {{\sum }_{j = 0}}^{{N}_{t} - 1} [ IDFT \{ {ϕ}_{Δ} ( i , j ) \} ] , \qquad [ Equation 3 ]$$

$$where {ϕ}_{Δ} ( i , j ) = E \{ \hat{H} \text{?} ( i , j ) \hat{H} \text{?} ( i , j ) \}$$

$$\text{?} \text{indicates text missing or illegible when filed}$$

Here, the IDFT{ } function is an inverse discrete Fourier transform (DFT) function, * is a complex conjugate operator, and the E{ } function is an arithmetic average operator. The channel data calculation circuit 330 may provide the obtained variance of the channel frequency response and the channel delay spread to the neural network learning circuit 350.

The SVD calculation circuit 320 may generate a beamforming matrix by receiving the estimated channel matrix from the channel estimation circuit 310 and performing singular value decomposition based on channel estimation. The beamforming matrix may be a matrix that maximizes channel capacity. The compression circuit 340 may receive the beamforming matrix from the SVD calculation circuit 320 and compress the received beamforming matrix to feed the beamformer (e.g., 21 of FIG. 2) back.

The neural network learning circuit 350 may perform learning to determine a channel type at least based on the variance of the channel frequency response and the channel delay spread obtained from the channel data calculation circuit 330. The neural network learning circuit 350 may be based on supervised learning. According to an embodiment, the neural network learning circuit 350 may have a feedback neural network structure. For example, after completing learning of an n-th iteration, the neural network learning circuit 350 may perform learning of an (n+1)-th iteration by re-inputting a channel type, which is a learning result. The neural network learning circuit 350 according to an embodiment will be described later.

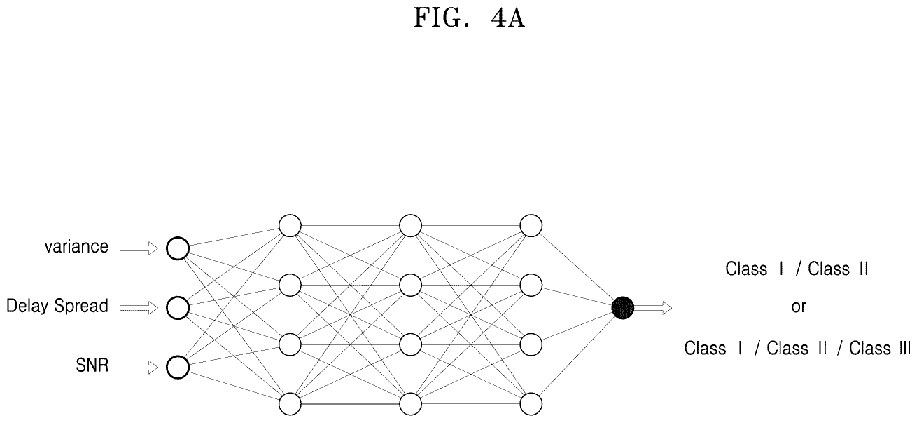

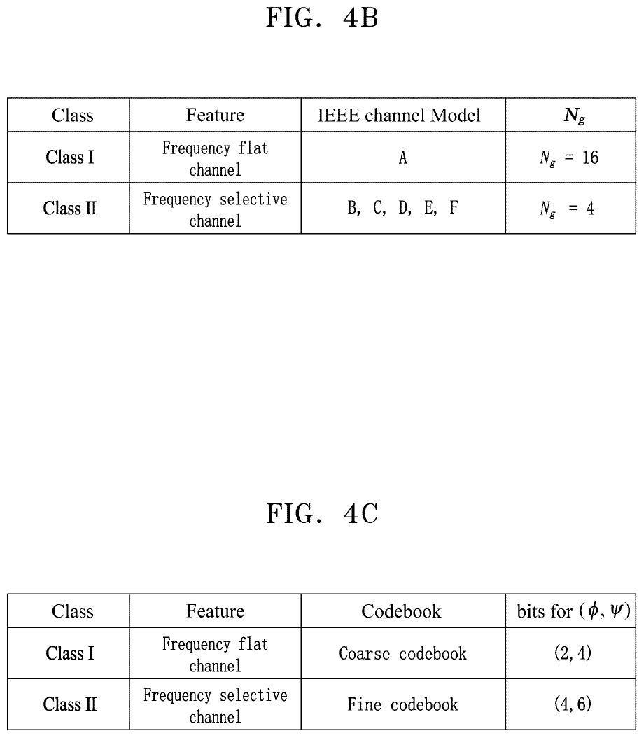

FIG. 4A is a diagram illustrating a first neural network model according to a comparative example.

Referring to FIG. 4A, the first neural network model according to the comparative example may determine an optimal channel type. An input set that is input to the first neural network model according to the comparative example may include a first value related to variance of the channel frequency response, a second value related to the channel delay spread, and a third value related to channel quality. The channel quality of the third value may be a signal to noise ratio (SNR), but is not limited thereto, and may further include a signal to interference plus noise ratio (SINR) and a signal to noise and distortion ratio (SINAD). The first to third values included in the input set are used to check a channel environment, and may be generated by the channel data calculation circuit 330 of FIG. 3.

The first neural network model according to the comparative example may generate an output based on an input set, and the output may correspond to a channel type determined based on a channel environment according to the input set. For example, the first neural network model according to the comparative example may output class I corresponding to “channel environment good” or class II corresponding to “channel environment bad” or class III corresponding to “channel environment worst”.

FIG. 4B illustrates an allocation table of subcarrier grouping according to a comparative example.

Referring to FIG. 4B, the beamformee according to the comparative example may perform adaptive feedback based on an output representing a channel type of the first neural network model of FIG. 4A. For example, the beamformee according to the comparative example may vary the size of subcarrier grouping according to the channel type.

According to an embodiment, the neural network learning circuit (e.g., 350 in FIG. 3) may output the channel type of class I. The beamformee may determine that the frequency flatness of the current channel is high based on the feedback of the channel type representing the class I. That is, the current channel may be a flat channel. For example, the channel representing class I may correspond to a channel type A. Since the current channel corresponds to a good channel environment, the beamformee may determine that even if the subcarrier interval fed back to the beamformer is increased the beamformer may be able to infer channel information for all subcarriers through interpolation. Accordingly, the beamformee may set the size of subcarrier grouping to be large. For example, the beamformee may set a value of Ng to 16. Ng corresponds to a size of subcarrier grouping.

According to an embodiment, the neural network learning circuit (e.g., 350 in FIG. 3) may output the channel type of class II. The beamformee may determine that the frequency flatness of the current channel is low based on the feedback of the channel type representing the class II. That is, the current channel may be a frequency selective channel. For example, the channel representing class II may correspond to any one of a channel type B, a channel type C, a channel type D, a channel type E, and a channel type F. Since the current channel corresponds to a bad channel environment, the beamformee may determine that the beamformer may be able to infer channel information for all subcarriers only if the subcarrier interval fed back to the beamformer is reduced. Accordingly, the beamformee may set the size of subcarrier grouping to be small. For example, the beamformer may set a value of Ng to 4.

FIG. 4C illustrates an allocation table of codebook sizes according to a comparative example.

Referring to FIG. 4C, the beamformee according to the comparative example may perform adaptive feedback based on an output representing a channel type of the first neural network model of FIG. 4A. For example, the beamformee according to the comparative example may vary the size of a codebook according to the channel type.

According to an embodiment, the neural network learning circuit (e.g., 350 in FIG. 3) may output the channel type of class I. Since the beamformee has a good current channel environment based on the feedback of the channel type representing class I, it is possible to determine to transmit a coarse codebook and set the size of the codebook to be small. For example, the beamformer may set the size of the codebook to (2, 4).

According to an embodiment, the neural network learning circuit (e.g., 350 in FIG. 3) may output the channel type of class II. The beamformee may determine that the frequency flatness of the current channel is low based on the feedback of the channel type representing the class II. That is, the current channel may be a frequency selective channel. Since the beamformer has a bad channel environment, it is possible to determine to transmit a fine codebook and set the size of the codebook to be large. For example, the beamformer may set the size of the codebook to (4, 6).

Summarizing the comparative example described above, the beamformee performed adaptive feedback to the beamformer, which varies the subcarrier grouping size and codebook size based on the output of the neural network, that is, the outputs of classes I and II for the channel environment. However, since the channel type is not fed back to the beamformer together, there is a disadvantage that the beamformer may not perform an adaptive transmission technique according to the channel type.

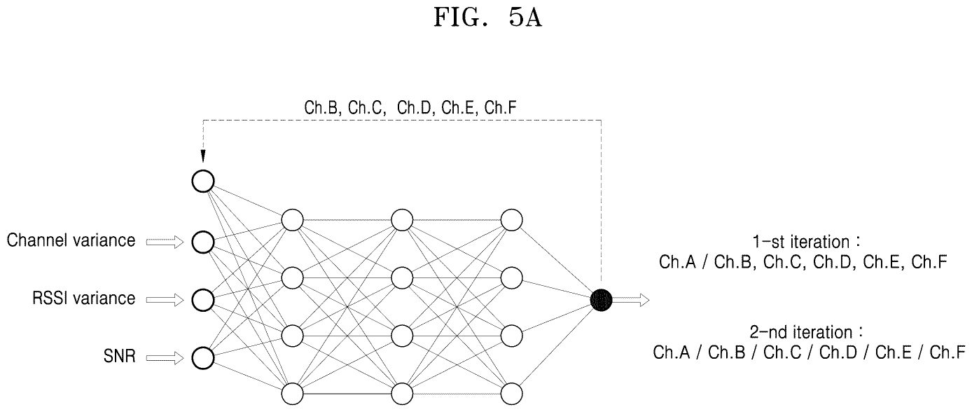

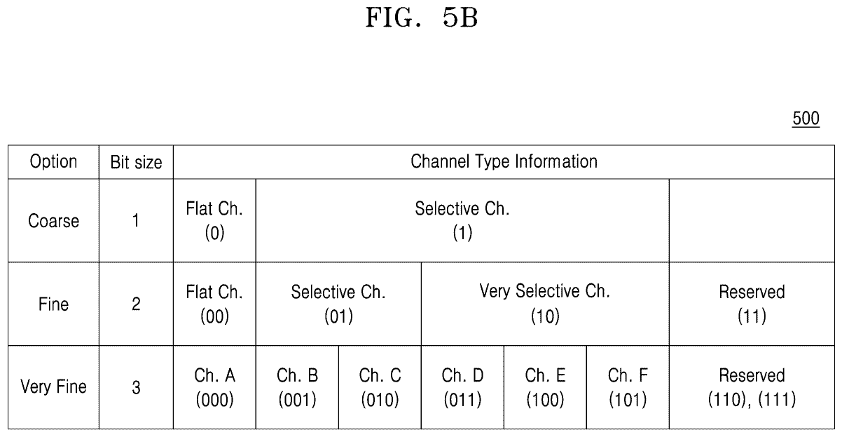

FIG. 5A is a diagram illustrating a second neural network model according to an embodiment.

Referring to FIG. 5A, the second neural network model may be a model that is loaded into the neural network learning circuit 350 of FIG. 3 to perform inference of the channel type. The second neural network model may determine a channel type. An input set that is input to the second neural network model may include a first value related to variance of the channel frequency response, a second value related to the channel delay spread, a third value related to channel quality, and a fourth value related to determination of the channel type. The first to fourth values included in the input set are used to check a channel environment, and may be generated by the channel data calculation circuit 330 and the neural network learning circuit 350 of FIG. 3.

According to an embodiment, the beamformee (e.g., 22 in FIG. 2) may perform at least two or more iterations. The beamformee may determine a channel type by performing first learning based on the first neural network model. In the case of the first learning, since the first learning is based on the first neural network model, the input set for learning the first neural network model may include a first value related to variance of the channel frequency response, a second value related to the channel delay spread, and a third value related to channel quality. The channel type determined according to the first learning may be either class I or class II. For example, in the case of a channel environment of a flat frequency, the first neural network model may output class I. As another example, in the case of a frequency selective channel environment, the first neural network model may output class II. Substantially, class II may be any one of channel type B, channel type C, channel type D, channel type E, and channel type F, but may not output an accurate channel type.

After the channel type is determined, the beamformee (e.g., 22 of FIG. 2) may perform the second learning by adding the determined channel type according to the first learning based on the second neural network model. The second neural network model may be different from the first neural network model. That is, the second learning may be performed by adding class I or class II, which is an output of the first learning, to the input set. The second neural network model may determine the channel type based on the second learning. For example, the second neural network model may output to which type of channel type A, channel type B, channel type C, channel type D, channel type E, and channel type F, which are defined in the standard, the current channel situation corresponds.

FIG. 5B illustrates a table for channel type feedback according to an embodiment.

Referring to FIG. 5B, a table 500 shows feedback of a channel type inferred through the second neural network model by the beamformee according to an option. For example, the option may be any one of coarse, fine, and very fine. The option may be requested by the beamformer (e.g., the beamformer requests the option in an NDPA packet), or the beamformer may set the option variably.

According to an embodiment, in the case of the coarse option, the beamformee may feedback, to the beamformer, a channel type either a channel having a flat channel type or a frequency selective channel. In the case of the coarse option, the beamformee may feed the channel type using 1 bit back. For example, the beamformee may transmit a value of “0” for a flat channel and a value of “1” for a frequency selective channel.

According to an embodiment, in the case of the fine option, the beamformee may feedback, to the beamformer, a channel type either a channel having a flat channel type, a frequency selective channel, or a very frequency selective channel. In the case of the fine option, the beamformee may feed the channel type using 2 bits back. For example, the beamformee may transmit a value of “00” for a flat channel, a value of “01” for a frequency selective channel, and a value of “10” for a very frequency selective channel. A value of “11” may correspond to “reserved”. The flat channel may correspond to channel type A, and in the case of each of the frequency selective channel and the very frequency selective channel, the mapped channel type may vary. For example, referring to FIG. 5B, a frequency selective channel may correspond to channel type B and channel type C, and a very frequency selective channel may correspond to channel type D, channel type E, and channel type F. However, embodiments are not limited thereto, and the frequency selective channel may correspond to the channel type B, the channel type C, and the channel type D, and the very frequency selective channel may correspond to the channel type E and the channel type F.

According to an embodiment, in the case of the very fine option, the beamformee may feed a clear channel type back. For example, the beamformee may be fed back to any one of channel type A, channel type B, channel type C, channel type D, channel type E, and channel type F. In the case of the very fine option, the beamformee may feed the channel type using 3 bits back. For example, the beamformee may feedback channel type A by transmitting a value of “000”, channel type B by transmitting a value of “001”, channel type C by transmitting a value of “010”, channel type D by transmitting a value of “011”, channel type E by transmitting a value of “100”, and channel type F by transmitting a value of “101”. A value of “110” and a value of “111” may correspond to “reserved”.

According to embodiments, as described above, the beamformee may feed the channel type back to the beamformer according to various options. The method of performing feedback in the beamformee may include at least transmitting a TB PPDU in response to a trigger frame, transmitting a CBR based on an NDPA packet and an NDP packet, or transmitting information including the channel type through a MAC header. Hereinafter, a method of performing feedback by the beamformee will be described later.

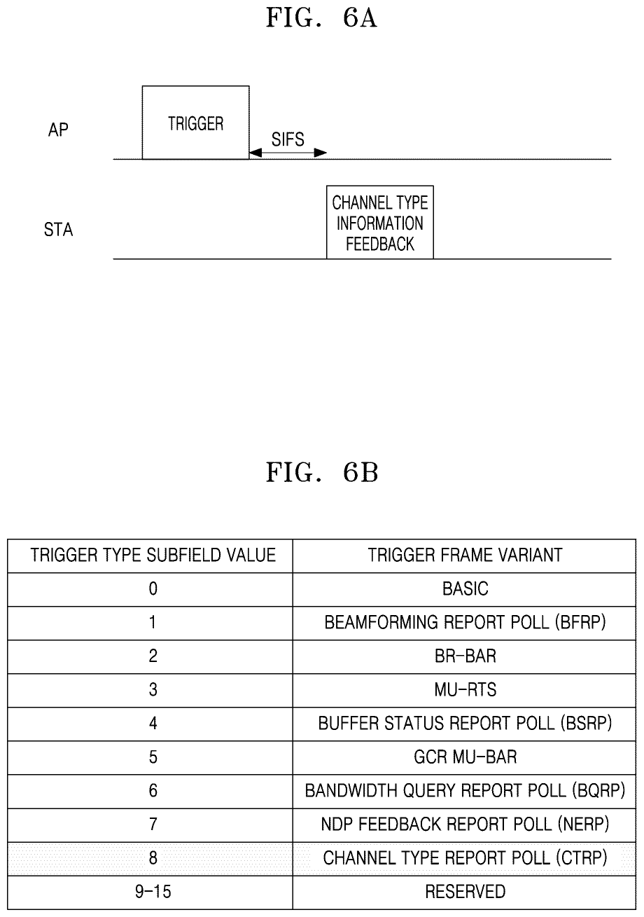

FIG. 6A is a timing diagram for explaining feedback based on a trigger frame according to an embodiment.

Referring to FIG. 6A, an access point AP may transmit a trigger frame to a station STA. The trigger frame may be a frame for requesting the station STA to transmit a PPDU. For example, the station STA may transmit a trigger-based (TB) PPDU to the beamformer in response to receiving the trigger frame.

According to an embodiment, the trigger frame may further include information for requesting the beamformee for feedback of a channel type. For example, referring to FIG. 6B, by newly defining a trigger type subfield value, feedback of a channel type may be requested from the beamformee. The trigger type subfield value “8” may be defined as a new value for requesting the beamformee for channel type feedback (e.g., “Channel Type Report Poll (CTRP)”). The beamformee may receive the trigger frame, decode the trigger type field among the trigger frames, and feed the channel type back in response to identifying that the corresponding field value is “8”.

As another example, the trigger frame may use a variable field of 1 bit to request feedback of the channel type from the beamformee. For example, the beamformer may set a trigger type subfield value to “1” when generating the trigger frame. The trigger type subfield value of “1” may correspond to the value for triggering an original beamforming report (e.g., “Beamforming Report Poll (BFRP)”). According to an embodiment, the beamformer may set a trigger type subfield value to “1” and simultaneously set a “Trigger Dependent Common Info” field to “1”. The “Trigger Dependent Common Info” field may be reserved when the trigger type subfield value is “1”. Therefore, if the trigger type subfield value is “1” and the “Trigger Dependent Common Info” field is assigned “1”, the beamformee may identify requesting of feedback of the channel type. Alternatively, the beamformee may identify that the feedback of the channel type is requested when the reserved 1 bit in a “Common Info” field or the reserved 1 bit in a “User Info” field is assigned “1”. The beamformee may feed the channel type back in response to identifying the feedback request of the channel type.

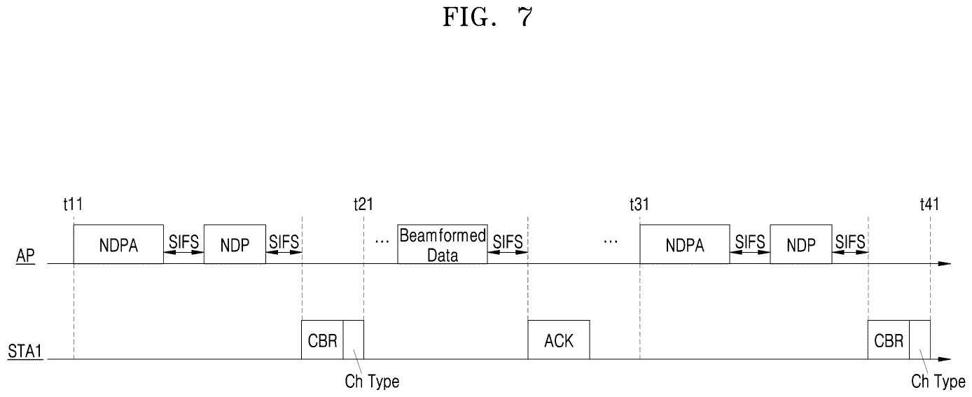

FIG. 7 is a timing diagram for explaining CBR-based feedback according to an embodiment.

Referring to FIG. 7, time t11 to time t21 are sections in which the channel sounding procedure is performed and may correspond to a first channel sounding section, time t21 to time t31 are sections in which data communication is performed and may correspond to the data communication section, and time t31 to time t41 are sections in which the channel sounding procedure is performed and may correspond to a second channel sounding section.

In the first channel sounding section, the access point AP may transmit an NDPA signal to the station STA. The station STA may identify that a following NDP packet will be transmitted based on receiving the NDPA signal from the access point AP. The access point AP may transmit a null data packet NDP to the station STA after a short interframe space (SIFS) time.

According to an embodiment, the access point AP may further include information requesting feedback of a channel type from the NDP. The access point AP may use two bits to request feedback of a channel type and indicate a feedback option. For example, when the 2 bits of “01” are included in the NDP, the station STA may identify that the channel type feedback is requested according to the coarse option among the options of FIG. 5B. When the 2 bits of “10” are included in the NDP, the station STA may identify that the channel type feedback is requested according to the fine option among the options of FIG. 5B. When the 2 bits of “11” are included in the NDP, the station STA may identify that the channel type feedback is requested according to the very fine option among the options of FIG. 5B.

The station STA may transmit CBR feedback to the access point AP after the SIFS time. The station STA may estimate a downlink channel based on the NDP and generate CBR feedback based on the estimation result. According to an embodiment, the station STA may transmit the channel type feedback to the access point AP together with the CBR feedback. The channel type feedback may be determined based on a feedback option indicated by two bits included in the NDP. For example, the determined channel type may be the channel type C. When 2 bits of “01” are included in the NDP, the station STA may transmit 1 bit of “1” to the access point AP as channel type feedback. When 2 bits of “10” are included in the NDP, the station STA may transmit 2 bits of “01” to the access point AP as channel type feedback. When 2 bits of “11” are included in the NDP, the station STA may transmit 3 bits of “010” to the access point AP as channel type feedback.

In the data communication section, the access point AP may transmit the beamformed data to the station STA. The access point AP may determine a beamforming matrix based on the CBR feedback received in the first channel sounding section and generate beamformed data based on the determined beamforming matrix. The access point AP may determine a transmission technique (e.g., an MCS level) based on the channel type feedback, and transmit beamformed data according to the determined transmission technique. The station STA may transmit an ACK signal indicating successful reception of beamformed data to the access point AP after the SIFS time. In this way, the access point AP may transmit a plurality of pieces of beamformed data to the station STA in the data communication section and receive a plurality of ACK signals from the station STA.

The access point AP may update the beamforming matrix based on the channel type fed back in the second channel sounding section. The access point AP may then generate beamformed data based on the updated beamforming matrix in the data communication section and transmit the generated beamformed data to the station STA.

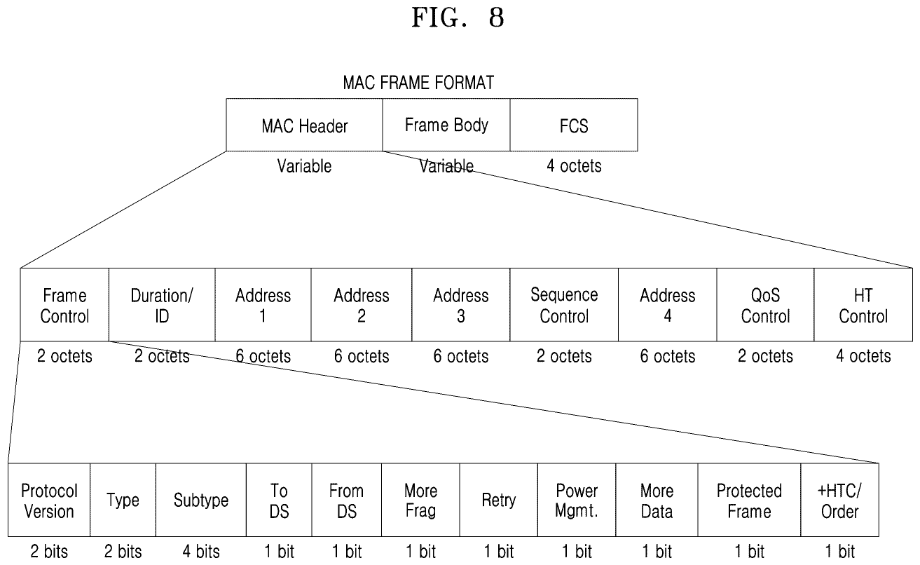

FIG. 8 is a diagram illustrating feedback based on a MAC header, according to an embodiment.

Referring to FIG. 8, the beamformee may include information including the channel type in the MAC header and transmit the result to the beamformer, not based on a TB PPDU in response to a trigger frame or CBR based on an NDPA and an NDP.

According to an embodiment, the beamformee may include at least one bit indicating the channel type in an “HT control” field among a plurality of fields included in the MAC header. For example, the beamformee may determine the bits to be included in the “HT control” field based on the feedback options requested by the NDPA. For example, in the case of the coarse option, the beamformee may add 1 bit to the “HT control” field to feed the result back to either a channel with a flat channel type or a frequency selective channel. As another example, in the case of the fine option, the beamformee may add 2 bits to the “HT control” field to feed the result back to any one of a channel with a flat channel type, a frequency selective channel, and a very frequency selective channel. As another example, in the case of the very fine option, the beamformee may add 3 bits to the “HT control” field to feed a clear channel type back.

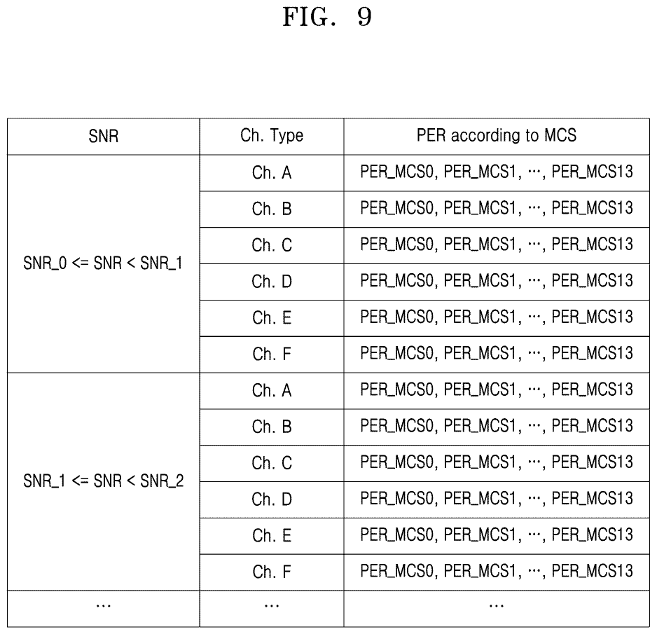

FIG. 9 is a table illustrating an adaptive MCS level according to an embodiment.

Referring to FIG. 9, the beamformer may variably set an MCS level based on an SNR and channel type feedback. According to an embodiment, the measured SNRs may be the same, while the feedback channel types may be different. For example, an SNR measured in a first channel may be greater than or equal to a first SNR (SNR_0) and less than a second SNR (SNR_1), and an SNR measured in a second channel may be greater than or equal to the second SNR (SNR_1) and less than a third SNR (SNR_2). However, the channel type fed back by the beamformee corresponding to the first channel may be a channel type A, and the channel type fed back by the beamformer corresponding to the second channel may be a channel type F. Since the measured SNR of the beamformer corresponding to the first channel is lower than the second SNR (SNR_1), it may be seen that although the environment is somewhat noisy, the channel is not frequency selective. For example, the beamformer corresponding to the first channel may determine the MCS level as 6. The beamformer corresponding to the second channel may see that even if the measured SNR is the same as the SNR of the first channel, the second channel is very selective to the frequency compared to the first channel. Accordingly, the beamformer of the second channel may determine the MCS level to be a level lower than 6 to ensure reliable transmission.

According to an embodiment, the fed back channel types may be the same, while the measured SNRs may be different. For example, the channel types fed back from the first channel and the second channel may be the same as the channel type A. The SNR measured in the first channel may be greater than or equal to the first SNR (SNR_0) and less than the second SNR (SNR_1). The SNR measured in the second channel may be greater than or equal to the second SNR (SNR_1) and less than the third SNR (SNR_2). That is, the SNR measured in the second channel may be greater than the SNR measured in the first channel. The beamformer corresponding to the first channel may identify that the first channel is an environment in which noise exists to some extent because the first channel is not selective to the frequency, but the measured SNR is low. For example, the beamformer corresponding to the first channel may determine the MCS level as 6. The beamformer corresponding to the second channel may identify that the second channel is not selective to the frequency and is a noise-free environment in the same manner as the first channel. Therefore, the beamformer corresponding to the second channel may determine the MCS level to be higher than 6.

In the embodiment described above, the MCS level is adaptively determined based on the feedback of the channel type and the SNR, but embodiments are not limited thereto. According to various embodiments, the beamformer may determine the MCS level based on at least one of the number of transmission/reception antennas, transmission bandwidth, and the number of transmission streams as well as the SNR.

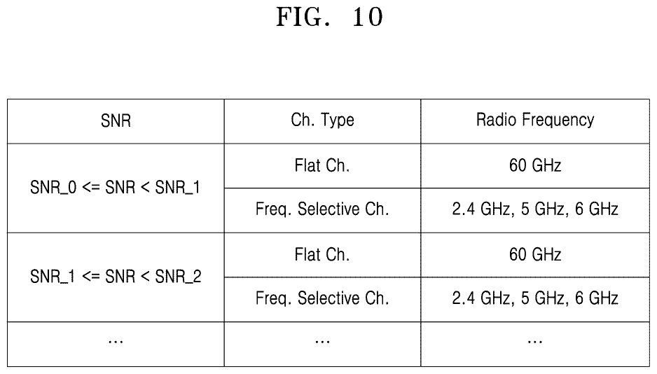

FIG. 10 is a table illustrating adaptive mmWave transmission according to an embodiment.

Referring to FIG. 10, the beamformer (e.g., 21 in FIG. 2) may variably determine whether to transmit mmWave based on an SNR and channel type feedback. According to an embodiment, the measured SNRs may be the same, while the feedback channel types may be different. For example, an SNR measured in a first channel may be greater than or equal to a first SNR (SNR_0) and less than a second SNR (SNR_1), and an SNR measured in a second channel may be greater than or equal to the second SNR (SNR_1) and less than a third SNR (SNR_2). However, the channel type fed back by the beamformee (e.g., 22 in FIG. 2) corresponding to the first channel may be a channel type A, and the channel type fed back by the beamformee corresponding to the second channel may be a channel type F. The beamformer corresponding to the first channel may determine mm Wave transmission because the first channel is flat in frequency. The beamformer corresponding to the second channel may see that even if the measured SNR is the same as the SNR of the first channel, the second channel is very selective to the frequency compared to the first channel. Therefore, the beamformer of the second channel may not perform mm Wave transmission considering the straightness of the mmWave.

According to an embodiment, the fed back channel types may be the same, while the measured SNRs may be different. For example, the channel types fed back from the first channel and the second channel may be the same as the channel type A. The SNR measured in the first channel may be greater than or equal to the first SNR (SNR_0) and less than the second SNR (SNR_1). The SNR measured in the second channel may be greater than or equal to the second SNR (SNR_1) and less than the third SNR (SNR_2). That is, the SNR measured in the second channel may be greater than the SNR measured in the first channel. The beamformer corresponding to the first channel may identify that the first channel is an environment in which noise exists to some extent because the first channel is flat in frequency, but the measured SNR is low. For example, the beamformer corresponding to the first channel may not perform mm Wave transmission. The beamformer corresponding to the second channel may identify that the second channel is flat in frequency and is a noise-free environment in the same manner as the first channel. Therefore, the beamformer corresponding to the second channel may determine to perform mmWave transmission.

In the embodiment described above, it is adaptively determined whether to transmit the mm Wave based on the feedback of the channel type and the SNR, but embodiments are not limited thereto. According to various embodiments, the beamformer may determine whether to transmit the mm Wave based on at least one of the number of transmission/reception antennas, transmission bandwidth, and the number of transmission streams as well as the SNR.

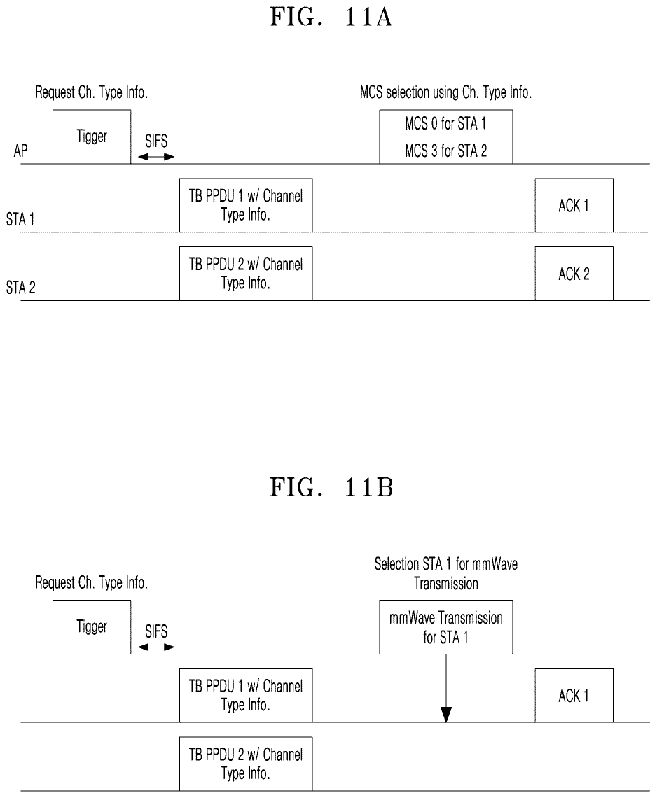

FIG. 11A is a timing diagram for adaptively applying an MCS level based on a trigger frame according to an embodiment.

Referring to FIG. 11A, an access point AP may broadcast a trigger frame. The trigger frame may include a plurality of user fields. For example, the plurality of user fields may include a first user field and a second user field. An AID (Association ID) of the first user field may correspond to an identification (ID) of a first station STA1, and an AID of the second user field may correspond to an ID of a second station STA2. According to an embodiment, the access point AP may set a value of a trigger type subfield to “8” in order to request channel type feedback.

The first station STA1 may receive the trigger frame and determine whether there is an AID matching the ID of the first station STA1 among a plurality of user fields. When an AID matching the ID of the first station STA1 exists, the first station STA1 may feed a channel type back based on the trigger type subfield. For example, the first station STA1 may include a channel type in a TB PPDU 1 and transmit the channel type-included TB PPDU 1 to the access point AP.

The second station STA2 may receive the trigger frame and determine whether there is an AID matching the ID of the second station STA2 among the plurality of user fields. When an AID matching the ID of the second station STA2 exists, the second station STA2 may feed a channel type back based on the trigger type subfield. For example, the second station STA2 may include a channel type in a TB PPDU 2 and transmit the channel type-included TB PPDU 2 to the access point AP.

According to an embodiment, the access point AP may adaptively determine a transmission technique for each of the first and second stations STA1 and STA2. For example, the channel type included in the TB PPDU 1 may correspond to the channel type F, and the channel type included in the TB PPDU 2 may correspond to the channel type C.

The access point AP may differently set the MCS level by variably applying the fedback channel type for each station. The access point AP may receive the TB PPDU 1 and identify that the channel communicating with the first station STA1 corresponds to the channel type F. The access point AP may transmit a beamformed data signal to the first station STA1 in response to the channel type F, and the signal transmitted to the first station STA1 may be based on MCS level 0. The access point AP may receive the TB PPDU 2 and identify that the channel communicating with the second station STA2 corresponds to the channel type C. The access point AP may transmit a beamformed data signal to the second station STA2 in response to the channel type C, and the signal transmitted to the second station STA2 may be based on MCS level 3.

The first station STA1 may transmit a first ACK (i.e., ACK 1) in response to receiving the beamformed data signal based on the MCS level 0. The second station STA2 may transmit a second ACK (i.e., ACK 2) in response to receiving the beamformed data signal based on the MCS level 3.

FIG. 11B is a timing diagram adaptively applying mmWave transmission based on a trigger frame according to an embodiment.

Referring to FIG. 11B, an access point AP may broadcast a trigger frame. The trigger frame may include a plurality of user fields. For example, the plurality of user fields may include a first user field and a second user field. An AID of the first user field may correspond to an identification (ID) of a first station STA1, and an AID of the second user field may correspond to an ID of a second station STA2. According to an embodiment, the access point AP may set a value of a trigger type subfield to “8” in order to request channel type feedback.

The first station STA1 may receive the trigger frame and determine whether there is an AID matching the ID of the first station STA1 among a plurality of user fields. When an AID matching the ID of the first station STA1 exists, the first station STA1 may identify that the value of the trigger type subfield is “8” and may feed the channel type back. For example, the first station STA1 may include a channel type in a TB PPDU 1 and transmit the result to the access point AP. For example, the channel type fed back by the first station STA1 may correspond to the channel type A.

The second station STA2 may receive the trigger frame and determine whether there is an AID matching the ID of the second station STA2 among the plurality of user fields. When an AID matching the ID of the second station STA2 exists, the second station STA2 may identify that the value of the trigger type subfield is “8” and may feed the channel type back. For example, the second station STA2 may include a channel type in a TB PPDU 2 and transmit the result to the access point AP. For example, the channel type fed back by the second station STA2 may correspond to the channel type F.

According to an embodiment, the access point AP may adaptively determine a transmission technique for each of the first and second stations STA1 and STA2. For example, the access point AP may receive the TB PPDU 1 and identify that the channel communicating with the first station STA1 is the channel type A. The access point AP may receive the TB PPDU 2 and identify that the channel communicating with the second station STA2 is the channel type F. The access point AP may variably determine whether to transmit mmWave based on the channel type fed back for each station. The access point AP may transmit a beamformed data signal to the first station STA1, and the signal transmitted to the first station STA1 may be transmitted in a mmWave frequency band. Since the access point AP has high frequency selectivity of the channel corresponding to the second station STA2, mmWave transmission may be skipped.

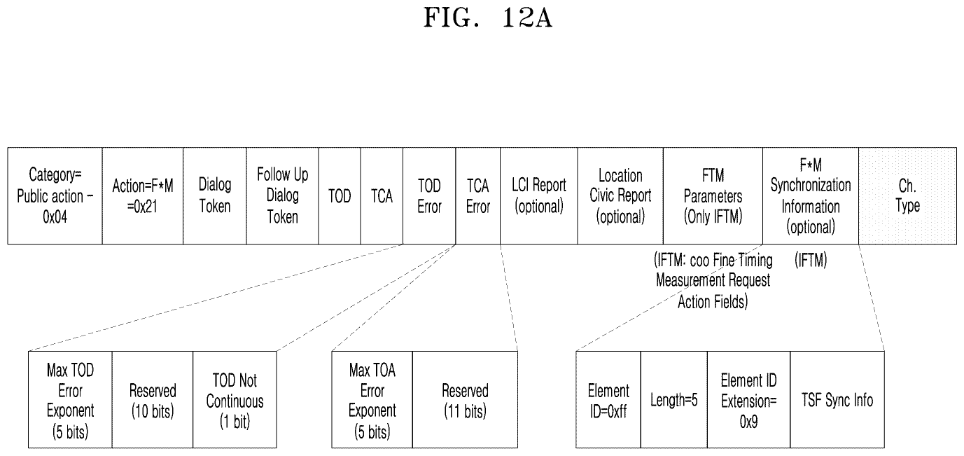

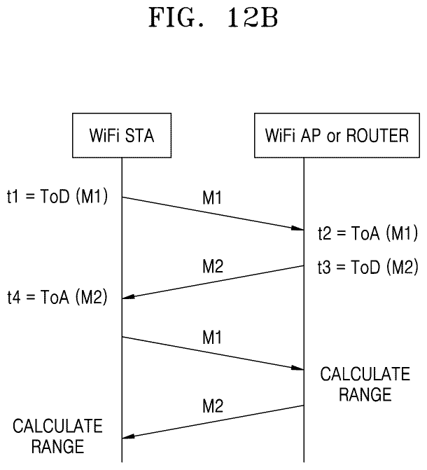

FIG. 12A illustrates an example of feeding back a channel state based on a fine timing measurement (FTM) action frame according to embodiments, and FIG. 12B is a signal exchange diagram for an FTM according to embodiments.

Referring to FIG. 12A, the beamformee may include information including the channel type in an FTM action frame for distance measurement and transmit the result to the beamformer, not based on a TB PPDU in response to a trigger frame, a CBR based on an NDPA and an NDP, or a MAC header.

According to an embodiment, the beamformee may newly establish a field for feedback of a channel type in the FTM action frame, and include one bit indicating the channel type in the newly established field. In this case, in the case of the FTM action frame for distance measurement, the beamformee only needs to inform whether the distance between the beamformee and the beamformer are in line of sight (LOS) or non-line of sight (NLOS). This is because if there is L multi-path fading between the beamformee and the beamformer, a channel impulse response depends on whether the LOS exists or not. For example, in the case of the LOS, the actual distance between the beamformee and the beamformer is measured using a time of arrival (TOA) of the LOS path. However, if there is no LOS path, the distance between the beamformee and the beamformer is measured using the TOA based on NLOS paths, resulting in a measurement error. Therefore, posting information on whether the signal is the LOS or NLOS may be effective in improving the accuracy of distance measurement.

For example, referring to FIG. 12B together, the station may transmit an FTM action frame (M1) to the access point AP at a first time t1. In this case, the station may add a channel type field indicating whether an LOS is present to the FTM action frame M1. For example, if the channel type determined by the station is the channel type A, the station may add the channel type field as “1”. When the channel type determined by the station is not channel type A (but, one of channel type B to channel type F), the station may add the channel type field as “0”.

At a second time t2, the access point AP may receive the FTM action frame M1 and determine whether the distance between the access point AP and the station is in an LOS or NLOS based on the channel type field. For example, when the channel type field is “1”, the access point AP may determine that an LOS path exists between the station STA and the access point AP. When the channel type field is “0”, the access point AP may determine that only NLOS paths exist between the station STA and the access point AP. Thereafter, at a third time t3, the access point AP may transmit, to the station STA, an FTM action frame M2 for distance measurement at the station STA. According to an embodiment, in the case of the FTM action frame M2 transmitted from the access point AP to the station STA, the channel type field may not be included. The station STA may receive the FTM action frame M2 at a fourth time t4, and calculate a distance based on a departure time of the first time t1 and an arrival time of the fourth time t4.

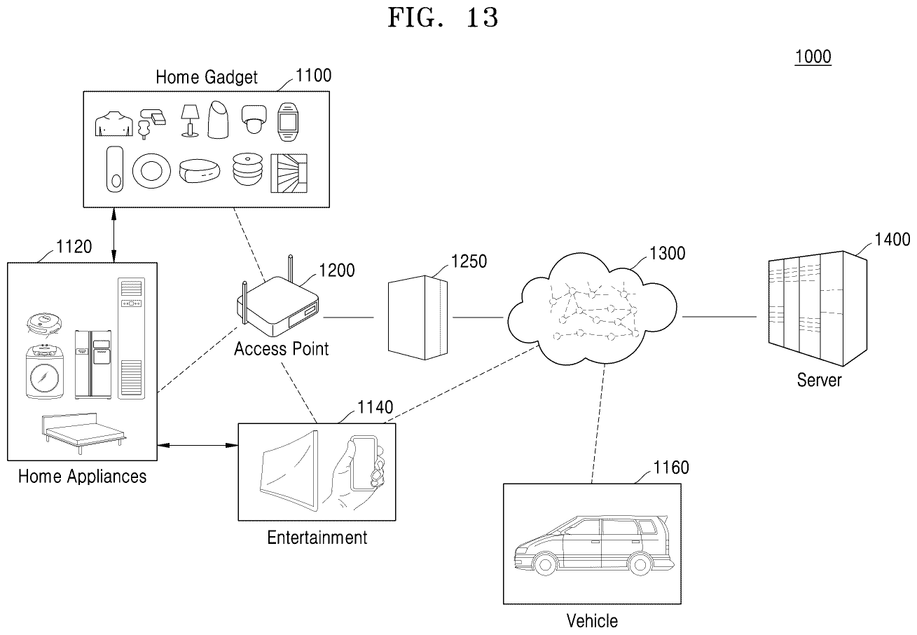

FIG. 13 is a conceptual diagram illustrating an IoT network system 1000 to which embodiments of the inventive concept are applied.

Referring to FIG. 13, the IoT network system 1000 may include a plurality of IoT devices 1100, 1120, 1140, and 1160, an access point 1200, a gateway 1250, a wireless network 1300, and a server 1400. Internet of Things (IoT) may refer to a network between objects using wired/wireless communication.

Each of the IoT devices 1100, 1120, 1140, and 1160 may form a group according to characteristics of each IoT device. For example, IoT devices 1100 may be grouped into a group of home gadget, IoT devices 1120 may be grouped into a group of home appliances, IoT devices 1140 may be grouped into a group of entertainment, IoT devices 1160 may be grouped into a group of vehicle, or the like. The plurality of IoT devices 1100, 1120, and 1140 may be connected to a communication network or other IoT devices through the access point 1200. The access point 1200 may be embedded in a single IoT device. The gateway 1250 may change a protocol to connect the access point 1200 to an external wireless network. The IoT devices 1100, 1120, and 1140 may be connected to an external communication network through the gateway 1250. The wireless network 1300 may include the Internet and/or a public network. A plurality of IoT devices 1100, 1120, 1140, and 1160 may be connected to the server 1400 providing a predetermined service through the wireless network 1300, and a user may use the service through at least one of the IoT devices 1100, 1120, 1140, and 1160.

According to embodiments, the plurality of IoT devices 1100, 1120, 1140, and 1160 may predict a channel type based on channel state data including variance and channel delay spreads and a previous learning result for the channel type, and may adopt a transmission technique optimal for the channel type by feeding back the predicted channel type. Accordingly, the IoT devices 1100, 1120, 1140, and 1160 may transmit and receive data according to the improved transmission capacity and provide high-quality services to users.

While aspects of the inventive concept have been particularly shown and described with reference to embodiments thereof, it will be understood that various changes in form and details may be made therein without departing from the spirit and scope of the following claims.

What is claimed is:

1. A method of operating a first device communicating with a second device through a channel in a wireless local area network (WLAN) system including the first device and the second device, the operating method comprising:
calculating state data of the channel using a signal received from the second device;
classifying a class of a channel type based on a first neural network using the state data as input;
classifying the channel type based on the classified class of the channel type and a second neural network using the state data as input; and
feeding back the classified channel type to the second device.

2. The operating method of claim 1, wherein the calculating of the state data of the channel further comprises:
performing channel estimation based on the signal received from the second device;
calculating a variance of the channel based on the result of the channel estimation; and
calculating a channel delay spread of the channel based on the calculated variance.

3. The operating method of claim 1, wherein the signal received from the second device comprises at least a trigger frame or a Null Data Packet (NDP).

4. The operating method of claim 3, wherein,
when the signal received from the second device corresponds to the trigger frame, the feeding back of the classified channel type to the second device further comprises:
decoding a trigger type subfield of the trigger frame; and
when the trigger type subfield instructs channel type feedback request, including information indicating the classified channel type in a trigger based physical protocol data unit (TB PPDU) and transmitting the result to the second device.

5. The operating method of claim 3, wherein, when the signal received from the second device corresponds to the NDP, the feeding back of the classified channel type to the second device further comprises including information indicating the classified channel type in a compressed beamforming report (CBR) and transmitting the result to the second device.

6. The operating method of claim 1, wherein the feeding back of the classified channel type to the second device further comprises including the information indicating the channel type in a high throughput (HT) control field in a media access control (MAC) header and transmitting the result to the second device.

7. A method of operating a second device communicating with a first device through a channel in a wireless local area network (WLAN) system including the first device and the second device, the operating method comprising:
transmitting a signal including information requesting the first device for feedback of a channel type;
receiving feedback regarding the channel type from the first device; and
determining a modulation coding scheme (MCS) level and/or a transmission frequency band of a signal transmitted to the first device based at least on the fedback channel type and a signal to noise ratio (SNR).

8. The operating method of claim 7, wherein the signal transmitted to the first device corresponds to a trigger frame or a Null Data Packet (NDP).

9. The operating method of claim 8, wherein, when the signal transmitted to the first device corresponds to the NDP, the feedback on the channel type is included in a compressed beamforming report (CBR).

10. The operating method of claim 8, wherein, when the signal transmitted to the first device corresponds to the trigger frame, the feedback on the channel type is included in a trigger based physical protocol data unit (TB PPDU).

11. The operating method of claim 7, wherein feedback on the channel type received from the first device is included in a high throughput (HT) control field in a media access control (MAC) header transmitted by the first device.

12. The operating method of claim 7, wherein the determining of the MCS level and/or transmission frequency band of the signal to be transmitted further comprises:
when the fedback channel type corresponds to a channel type A of a flat frequency, setting the MCS level high; and
when the fedback channel type corresponds to a frequency selective channel type, setting the MCS level low.

13. The operating method of claim 7, wherein the determining of the MCS level and/or transmission frequency band of the signal to be transmitted further comprises:
when the fedback channel type corresponds to a channel type A of a flat frequency, setting the signal to be transmitted in a mmWave frequency band; and
when the fedback channel type corresponds to the frequency selective channel type, setting the signal to be transmitted in a frequency band lower than the mmWave frequency band.

14. A wireless local area network (WLAN) system comprising:
a first device configured to calculate state data of a channel using a signal received from a second device, classify a class of a channel type class based on a first neural network using the state data as input, classify the channel type based on the classified class of the channel type, and a second neural network using the state data as input, and feed the classified channel type back to the second device; and
a second device configured to determine a modulation coding scheme (MCS) level and/or a transmission frequency band of a signal transmitted to the first device at least based on the fedback channel type.

15. The system of claim 14, wherein the first device is further configured to:
perform channel estimation based on the signal received from the second device;
calculate a variance of the channel based on the result of the channel estimation; and
calculate a channel delay spread of the channel based on the calculated variance.

16. The system of claim 14, wherein the signal received from the second device to the first device comprises at least a trigger frame or a Null Data Packet (NDP).

17. The system of claim 16, wherein, when the signal received from the second device to the first device is the trigger frame, the first device is further configured to:
decode a trigger type subfield of the trigger frame; and
when the trigger type subfield instructs a channel type feedback request, include information indicating the classified channel type in a trigger based Physical Protocol Data Unit (TB PPDU) and transmit the result to the second device.

18. The system of claim 16, wherein, when the signal received from the second device to the first device is the NDP, the first device is further configured to include information indicating the classified channel type in a compressed beamforming report (CBR) and transmit the result to the second device.

19. The system of claim 14, wherein the second device is further configured to:
when the fedback channel type corresponds to a channel type of a flat frequency, set the MCS level high; and
when the fedback channel type corresponds to a frequency selective channel type, set the MCS level low.

20. The system of claim 14, wherein the second device is further configured to:
when the fedback channel type corresponds to a channel type of a flat frequency, set the signal to be transmitted on a mmWave frequency band; and when the fedback channel type corresponds to a frequency selective channel type, set the signal to be transmitted in a frequency band lower than the mmWave frequency band.
